(19) United States
(12) Patent Application Publication
(10) Pub. No.: US 2026/0167162 A1
(43) Pub. Date: Jun. 18, 2026

(54) ABS DEVICE FOR A HYDRAULIC BRAKING SYSTEM OF A CYCLE OR MOTORCYCLE OR OF A LIGHT VEHICLE

(71) Applicant: Blubrake S.p.A., Milano (MI) (IT)

(72) Inventors: Fabio TODESCHINI, Milano (MI) (IT); Daniele BERRETTA, Milano (MI) (IT); Andrea RUZZON, Milano (MI) (IT)

(73) Assignee: Blubrake S.p.A., Milano (MI) (IT)

(21) Appl. No.: 19/412,202

(22) Filed: Dec. 8, 2025

(30) Foreign Application Priority Data
Dec. 17, 2024 (IT) 102024000028719

(51) Int. Cl. B60T 8/1761; B60T 8/17; B60T 8/171; B60T 8/172; B60T 8/1755; B60T 8/58; B60T 13/14; B60T 13/68; B60T 17/22; B62L 3/02

(52) U.S. Cl. CPC B60T 8/17616; B60T 8/1706; B60T 8/171; B60T 8/172; B60T 8/17551; B60T 8/58; B60T 13/142; B60T 13/686; B60T 17/221; B62L 3/023; B60T 2230/03; B60T 2240/02; B60T 2250/04

(57) ABSTRACT

An ABS device of a cycle includes an electrically actuated valve unit, switchable between a first operating condition in which a master cylinder is placed in communication with an actuator cylinder of a brake device, and a second operating condition, in which the communication is interrupted and the actuator cylinder is placed in communication with a fluid accumulator. An electronic controller is configured for controlling the position of the movable member of the fluid accumulator, during an activation of the ABS function and a deactivation of the ABS function, to cause a non-abrupt, but progressive, variation of the pressure in the line connecting to the actuator cylinder of the brake device.

### FIELD OF THE INVENTION

The present invention relates to an ABS device for a hydraulic braking system of a cycle or motorcycle, for example for an electric bicycle or a light two-or three-wheeled electric vehicle, of the type comprising:
an inlet, to be hydraulically connected to a master cylinder associated with a brake lever,
an outlet, to be hydraulically connected to an actuator cylinder associated with a brake device,
a fluid accumulator, having an accumulation chamber defined by a movable member within a cavity, said movable member being normally in a starting position corresponding to a minimum volume of the accumulation chamber,
an electrically actuated valve unit switchable between:
a first operating condition, in which said inlet and said outlet communicate with each other and said accumulation chamber of the fluid accumulator is isolated, and
a second operating condition, in which the communication between said inlet and said outlet is interrupted and the accumulation chamber of said fluid accumulator is in communication with said outlet, and
an electronic controller, configured for detecting a condition in which activation of an ABS function is required and which, in said condition, is further configured for causing a switching of said valve unit from the first operating condition to the second operating condition and for enabling a movement of the movable member of the fluid accumulator in a direction corresponding to an increase in the volume of the accumulation chamber, so as to cause a decrease in pressure in the connection line between said outlet and the actuator cylinder of the brake device.

### PRIOR ART

An ABS device of the type indicated above is for example described and illustrated in document EP 3 789 256 B1.

In general, ABS devices specifically dedicated to hydraulic braking systems for bicycles, in particular for pedal-assisted bicycles, have been developed for some time. The solutions proposed in the past are fundamentally of two different types.

A first type of solution provides a first hydraulic line for the connection between the master cylinder associated with the brake lever and the actuator cylinder associated with the brake device (typically, a disc brake caliper), and a second hydraulic line for the connection of the actuator cylinder of the brake device with the accumulation chamber of a passive-type fluid accumulator, having a movable member that can move against the action of a spring due to the pressurized fluid entering the accumulator. An electrically actuated valve, normally open, is interposed in the first hydraulic line, to allow a flow of fluid from the master cylinder, associated with the brake lever, to the actuator cylinder, associated with the brake device, during normal braking. The second hydraulic line also includes an electrically actuated valve which is normally closed, so as to isolate the fluid accumulator from the actuator cylinder of the brake device.

A condition in which activation of the ABS function is required is normally detected by means of a sensor configured for detecting a decrease in the rotational speed of the wheel to which the brake device is associated (typically the front wheel of the bicycle), indicative of an incipient locking of the wheel itself. Alternatively, the need to activate the ABS function is detected by verifying when the rear wheel of the bicycle tends to lift off the ground, by monitoring the load acting on the axle of the rear wheel of the bicycle. A further way to detect the need for ABS function intervention consists of directly monitoring the pressure applied to the actuator cylinder of the brake device.

When the ABS function must be activated, in known solutions of this first type, an electronic controller causes the closure of the electrically actuated valve interposed in the first hydraulic line, so as to isolate the master cylinder, associated with the brake lever, from the actuator cylinder, associated with the brake device, and at the same time the opening of the electrically actuated valve interposed in the second hydraulic line is caused, so as to enable the flow of fluid from the actuator cylinder of the brake device towards the accumulation chamber of the fluid accumulator.

An example of an ABS device of this first type has been described and illustrated in document DE 19508915 A1. Further examples of ABS devices of this type have been described in documents DE 101 58 382 A1, EP 2 943 395 B1, WO 2017/115171 A2, WO 2019/159029 A1, EP 3 753 835 B1 and EP 3 789 256 B1.

Still with reference to the prior art, a second type of solution provides a single hydraulic line for the connection between the master cylinder associated with the brake lever and the actuator cylinder associated with the brake device and an ABS device interposed in said hydraulic line and substantially constituting an active-type fluid accumulator, in which the movement of the movable member of the accumulator in both directions is positively controlled by an electric motor. The accumulation chamber of said device is permanently in communication with the downstream section of the hydraulic line, connected to the actuator cylinder of the brake device. At the same time, the accumulation chamber of the device is also connected to the upstream section of the hydraulic line, communicating with the master cylinder associated with the brake lever, with the interposition of a one-way valve comprising a shutter elastically recalled towards a closed position, such as to allow a flow of fluid only from said downstream section of the hydraulic line towards said upstream section. The movable member of the fluid accumulator is configured so as to engage the shutter of said one-way valve and maintain it in an open condition when the movable member of the device is in its starting position.

In devices of this second type, during normal braking, the fluid flows from the master cylinder associated with the brake lever to the actuator cylinder associated with the brake device, passing through the accumulation chamber of the device, since said one-way valve is kept open by the movable member of the device, which is in its starting position. When the need to activate an ABS function is detected (in one of the ways described above), the electric motor controlling the movable member commands a movement of the movable member away from its starting position, so as to cause the closure of the one-way valve and an increase in the volume of the accumulation chamber, which determines a decrease in pressure of the actuator cylinder of the brake device, with a consequent decrease or cancellation of the braking action.

An example of a solution of this second type is described in document EP 3 789 256 B1. Further examples of solutions of this type are described in documents EP 2 985 198 B1, U.S. Pat. No. 4 275 934 A and US 2020/324752 A1. The same Applicant has developed solutions of this type, which have been described in documents EP 4 132 841 B1 and EP 4 132 821 B1.

All the aforementioned prior art solutions are effective in avoiding the risk of wheel locking following a loss of adhesion between the wheels and the ground during braking. However, there is a need for further improvements in this field from various points of view.

A first need is to produce an ABS device that is as simple as possible in construction, light and low-cost.

A further important need is to ensure reliable operation of the device in every operating condition, always guaranteeing safety for the user, even in case of failure of the ABS device, ensuring in particular the full operation of the braking system even when the ABS device is faulty or in case of depletion of the charge of the electric supply battery with which the vehicle is equipped or, more generally, in a condition in which, for any reason, the electric power supply to the ABS device is lost.

Yet a further important need is to reduce as much as possible the energy required for activating the ABS device.

An ABS device of the type indicated at the beginning of the present description is described and illustrated in document EP 3 789 256 B1 already cited above. In said prior art solution, an electrical actuator, in the form of a solenoid, is also associated with the fluid accumulator, which however has the sole function of pushing the movable member of the fluid accumulator towards its starting position when the ABS function is no longer necessary, so as to cause fluid to flow out of the fluid accumulator, without the need to provide a spring that recalls the movable member towards its starting position. Said prior art solution is however complex and expensive and does not allow precise control of the pressure in the downstream line connected to the actuator cylinder of the brake device, on which the ABS effect depends.

In view of solving the aforementioned drawbacks, the Applicant has already proposed some solutions, which have been the subject of Italian patent applications IT 10 2023 0000 14 319 and IT 10 2023 000027030, both still secret at the filing date of the present application. However, there is a need for further improvements in this field.

An ABS device according to the preamble of claim 1 is also known from document US 2023/234544 A1. Said document (see in particular paragraphs 0063 and 0064) illustrates a solution in which the pressure reduction during ABS activation is instantaneous and in which the pressure restoration is also substantially instantaneous, since it occurs by means of a spring following an interruption, without any modulation, of the current supply to a solenoid.

Another solution is known from document JP 2006 069303 A.

### OBJECT OF THE INVENTION

The main object of the present invention is to effectively solve all the problems of the prior art that have been mentioned above.

In particular, a first object of the invention is to produce an ABS device that is efficient in operation, simple in construction and low-cost.

A further object of the invention is to produce an ABS device that guarantees full safety for the user in every operating condition, ensuring the correct operation of the braking system even when the ABS device is faulty, i.e., without electrical power supply.

A further object of the invention is to produce an ABS device that involves minimum energy consumption for activating the ABS function.

### SUMMARY OF THE INVENTION

In view of achieving one or more of the aforementioned objects, the invention has for its object an ABS device having all the characteristics that have been indicated at the beginning of the present description and further characterized in that:
said electronic controller is configured for controlling the position of the movable member of the fluid accumulator, both during an activation of the ABS function and during a deactivation of the ABS function, so as to cause a non-abrupt, but progressive, variation of the pressure in the connection line to the actuator cylinder of the brake device, both during an activation of the ABS function and during a deactivation of the ABS function,
said progressive pressure variation being determined by the electronic controller as a function of:
a first parameter, which is the rotational speed of said wheel to which the brake device is associated, detected or calculated based on a signal emitted by a sensor intended to be associated with the wheel, and also as a function of:
a second parameter, which is:
the pressure in the actuator cylinder (3) of the brake device,

or the deceleration of the vehicle detected or calculated based on a sensor intended to be associated with the vehicle.

In a preferred form of embodiment, the ABS device is further characterized in that:
the switching of said valve unit between the first operating condition and the second operating condition is controlled by a solenoid that is operatively associated with the movable member of said fluid accumulator and that is configured and arranged in such a way that when said solenoid is energized it causes:
   both a switching of said valve unit from the first operating condition to the second operating condition,
   and the application of a force on said movable member of the fluid accumulator tending to push the movable member towards its starting position corresponding to a minimum volume of the accumulation chamber, and
when the electronic controller determines said condition in which activation of the ABS function is required, the electronic controller is programmed to execute the following operations:
in a first phase, supply a relatively high level of electric current to said solenoid, so as to switch the valve unit from the first operating condition to the second operating condition, but pushing the movable member of the fluid accumulator into its starting position,
   in a second subsequent phase, progressively decrease the current intensity of the electric current supplied to said solenoid, in such a way that the valve unit remains in its second operating condition, while the movable member of the fluid accumulator moves away from its starting position, so as to cause a progressive decrease in pressure in the connection line between said outlet and the actuator cylinder of the brake device,
   in a third subsequent phase, progressively increase the current intensity of the electric current supplied to said solenoid, in such a way that the movable member of the fluid accumulator returns to its starting position, determining a progressive increase in pressure in the connection line between said outlet and the actuator cylinder of the brake device, while the valve unit remains in its second operating condition,
   in a fourth subsequent phase, after the movable member of the fluid accumulator has returned to its starting position, and once the ABS functionality is no longer necessary, the electronic controller interrupts the supply of electric current to said solenoid, whereby the valve unit returns to its first operating condition while the movable member of the fluid accumulator remains in its starting position.

In the second phase mentioned above, the current flowing in the solenoid is reduced proportionally to the force generated by the fluid on the movable member of the fluid accumulator, so as to allow the movable member to move and therefore progressively reduce the pressure on the caliper side, to ensure safe braking. Similarly, when the ABS function is no longer necessary, the pressure on the caliper side is progressively restored.

In an example, said valve unit includes:
a main passage connecting said inlet with said outlet,
a first valve interposed in said main passage between said inlet and said outlet and which is in an open position in said first operating condition of the valve unit,
a second valve that controls a connection between said main passage and the accumulation chamber of the fluid accumulator, and which is in a closed position in said first operating condition of the valve unit,
an actuator member, movable against the action of a spring due to an energization of said solenoid in such a way as to simultaneously bring the first valve into a closed position and the second valve into an open position, and
in such a way that, in case of lack of electrical power to the solenoid, the spring associated with the actuator member recalls the actuator member into the position in which it maintains the first valve open and the second valve closed, even in the presence of an increase in pressure in said main passage determined by a braking action.

The invention also has for its object the controlling method implemented by means of the ABS device defined above.

### BRIEF DESCRIPTION OF THE FIGURES

Further characteristics and advantages of the invention will result from the following description with reference to the attached drawings, provided by way of non-limiting example only, in which:

FIG. 1 is a schematic side view of a bicycle with an electric assistance motor, using an ABS device according to the present invention,

FIGS. 2, 3 illustrate a schematic of a hydraulic braking system including an ABS device according to the invention, respectively in a first operating condition and in a second operating condition,

FIGS. 4, 5, 6, 7 are sectional views of an example of embodiment of the ABS device according to the invention, in four different operating conditions,

FIGS. 4A, 5A, 6A, 7A illustrate a detail of FIGS. 4, 5, 6, 7, respectively, on an enlarged scale,

FIG. 8 is a perspective view of the ABS device of FIGS. 4-7,

FIG. 9 is a block diagram showing the method for controlling the current supplied to the solenoid of the ABS device according to the invention, and

FIG. 10 shows the variation of signals indicative of the vehicle speed, of the rotational speed of the front wheel of the vehicle, of a factor indicative of the slip of the front wheel relative to the ground, of the pressure in the master cylinder and of the pressure in the actuator cylinder of the brake device, before and during the activation of an ABS function.

### DETAILED DESCRIPTION OF THE INVENTION

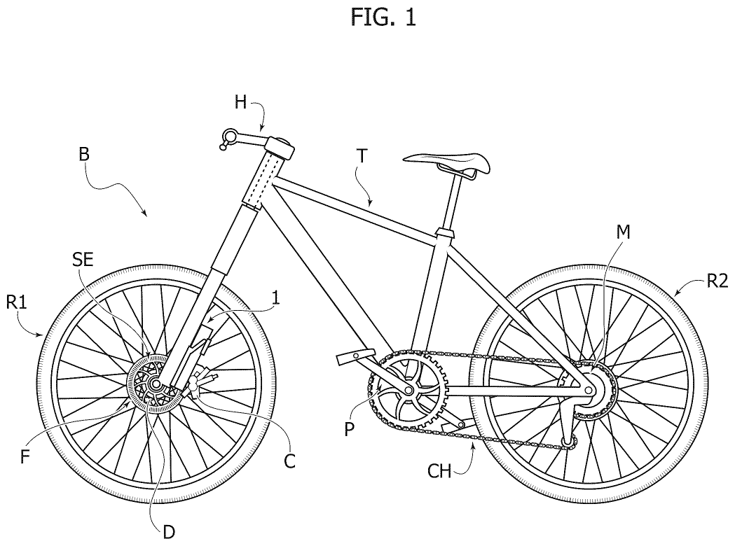

FIG. 1 schematically shows a bicycle B, comprising a frame T that rotatably supports a crank unit P, connected by a chain transmission CH to the hub of a rear wheel R2 which is rotatably supported by the frame T. An electric motor M is associated with the hub of the rear wheel R2 to assist the cyclist's action on the pedals. The frame T includes a steering tube that rotatably supports a steering stem having an upper end connected to a handlebar H and a lower end connected to a front fork of the bicycle, which rotatably supports a front wheel R1. A disc brake device F is associated with the wheel R1, including a disc D rotationally connected with the hub of the front wheel R1 and a hydraulically operated brake caliper C, carried by one of the two arms of the front fork of the bicycle. FIG. 1 does not show the brake device associated with the rear wheel R2, which can also be, for example, a hydraulically operated disc brake device.

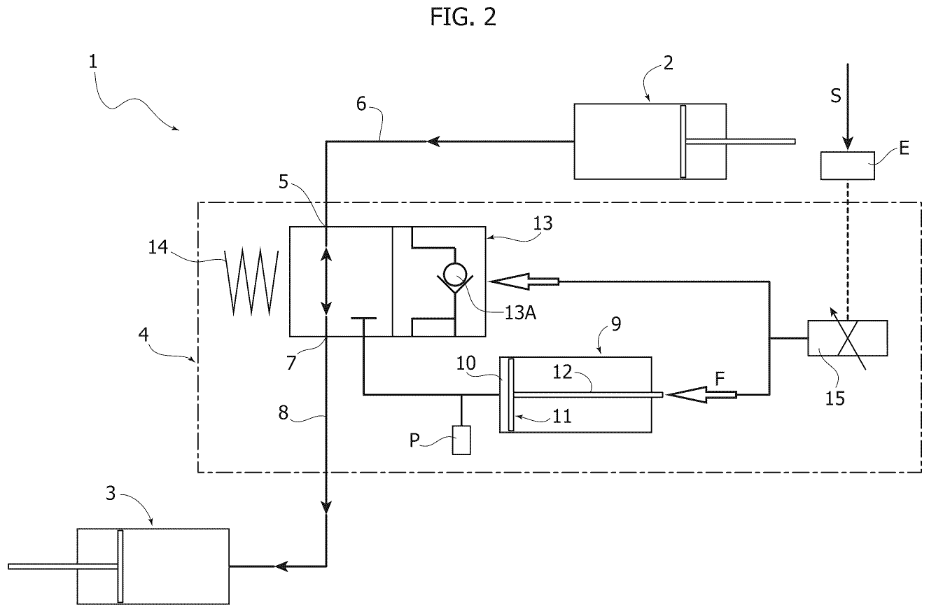

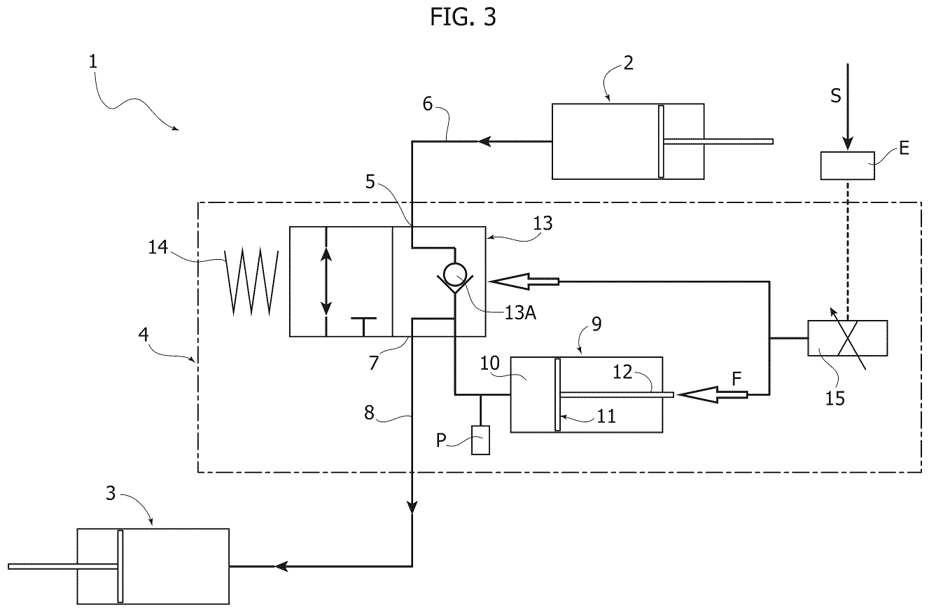

The brake device F associated with the front wheel is controlled by a hydraulic braking system which is described in detail below, with reference to FIGS. 2, 3, and which includes an ABS device 1, also described in detail herein below.

FIG. 1 shows an example wherein the ABS device 1 is carried by one of the two arms of the front fork of the bicycle, adjacent to the disc brake device F associated with the front wheel R1. However, the arrangement of the ABS device on the bicycle can also be different. For example, the ABS device can be mounted within one of the tubes that are part of the frame T, as taught by document DE 10 2019 118 949 A1 of which the Applicant is co-owner, or inside the steering stem, as taught by document IT 102023000027039 of the Applicant (still not available to the public at the date of the present invention).

With reference to FIGS. 2, 3, the reference numeral 1 indicates as a whole the hydraulic braking system of the bicycle, including a master cylinder 2, associated in any known manner with a brake lever of a bicycle (not illustrated), an actuator cylinder 3, associated in any known manner with the brake device F, and an ABS device, schematically indicated as a whole with 4.

The ABS device 4 comprises an inlet 5 hydraulically connected to the master cylinder 2 of the brake lever, via a hydraulic line 6, and an outlet 7 hydraulically connected to the actuator cylinder 3 of the brake caliper via a hydraulic line 8.

The ABS device 4 comprises a fluid accumulator 9 having an accumulation chamber 10 defined by a movable member 11 which in the example is a piston provided with a rod 12. The piston 11 is movable within a cavity of the body of the fluid accumulator 9 and is normally in a starting position (illustrated in FIG. 2) corresponding to a minimum volume of the accumulation chamber 10.

The ABS device 4 further comprises a valve unit, indicated as a whole with 13, electrically actuated, switchable between a first operating condition and a second operating condition.

In the first operating condition of the valve unit 13, illustrated in FIG. 2, the valve unit 13 connects the inlet 5 and the outlet 7 to each other, whereby, in this condition, the braking system is able to operate normally, allowing the user to cause the activation of the brake caliper C (FIG. 1) by acting on the brake lever. The valve unit 13 is normally maintained in said first operating condition, illustrated in FIG. 2, by elastic means 14.

The valve unit 13 can be switched, via energization of a solenoid 15 (described in more detail below) from the first operating condition illustrated in FIG. 2 to the second operating condition illustrated in FIG. 3, in which the communication between the inlet 5 and the outlet 7 is interrupted and the accumulation chamber 10 of the fluid accumulator 9 comes into communication with the outlet 7.

The electrical power supply of the solenoid 15 is controlled by an electronic controller E of the ABS device. The electronic controller E is configured for detecting a condition in which activation of an ABS function is required, by receiving a signal S indicative of such necessity, coming from a sensor SE (see FIG. 1), of any known type, with which the bicycle is provided, suitable to allow the detection or calculation of the angular rotational speed of the front wheel R1 of the bicycle. In the example of FIG. 1, the sensor SE is supported adjacent to the brake disc D of the front wheel R1.

The main characteristic of the invention lies in the fact that the electronic controller E is configured for controlling the position of the movable member 11 of the fluid accumulator 9, both during an activation of the ABS function and during a deactivation of the ABS function, in such a way as to cause a non-abrupt, but progressive, variation of the pressure in the connection line to the actuator cylinder 3 of the brake device.

The progressive pressure variation is determined by the electronic controller as a function of two parameters. A first parameter is the rotational speed of the wheel R1 to which the brake device is associated, detected or calculated based on the signal S emitted by the sensor SE. The second parameter is either the force applied to the actuating lever of the brake device (or a parameter correlated thereto, such as the pressure in the master cylinder 2) or the deceleration of the vehicle detected or calculated based on a sensor intended to be associated with the vehicle (for example an accelerometer or an inertial platform).

The aforementioned characteristics are also applicable in the case the ABS device is configured differently from how it is illustrated in FIGS. 2, 3, for example also to an ABS device that had a first solenoid valve for controlling the communication between the master cylinder 2 and the actuator cylinder 3 of the brake device, and a second solenoid valve for controlling the communication of the chamber 10 of the fluid accumulator 9 with the line 8 connecting to the actuator cylinder (3).

However, the implementation schematically illustrated in FIGS. 2, 3 constitutes a preferred form of embodiment of the invention.

With reference again to FIGS. 2, 3, when the electronic controller E determines, based on the signal S indicative of the angular velocity of the front wheel R1, a necessity to activate the ABS function, the electronic controller E supplies electric current to the solenoid 15, in the manner that will be described in more detail below, so as to cause the switching of the valve unit 13 from its first operating condition illustrated in FIG. 2 to its second operating condition illustrated in FIG. 3.

In the preferred form of embodiment of the invention, the solenoid 15 that controls the switching of the valve unit 13 is a solenoid that is operatively associated with the movable member 11 of the fluid accumulator 9 and that is configured and arranged in such a way that, when it is activated, it tends to apply to the movable member 11 of the fluid accumulator 9 a force F1 tending to maintain the movable member 11 in its starting position, corresponding to the minimum volume of the accumulation chamber 10.

Therefore, the solenoid 15 is able to simultaneously control both the switching of the valve unit 13 (in the manner that will be described in detail below), and a push applied to the movable member 11 of the fluid accumulator 9, tending to push the movable member 11 towards its starting position corresponding to the minimum volume of the accumulation chamber 10.

In a preferred form of embodiment, as will become apparent below, the solenoid 15 is mounted coaxially around the fluid accumulator 9 in a position wherein it is also suitable to cooperate with an actuator member (described in detail below) that controls the operating condition of the valve unit 13.

A pressure sensor P1 is suitable for detecting the pressure in the actuator cylinder 3 of the brake caliper and for sending a signal indicative of the detected pressure to the electronic controller E.

The operation of the ABS device schematized in FIGS. 2, 3 is as follows.

During normal use of the bicycle, when the ABS function is not required, the solenoid 15 is not supplied with electric current and the valve unit 13 is in its first operating condition illustrated in FIG. 2. In this condition, an action on the brake lever causes the transfer of fluid from the master cylinder 2, through the line 6, the valve unit 13 and the line 8, to the actuator cylinder 3 of the brake caliper, which is thus normally activated.

The spring 14 is configured in such a way as to be able to counteract the hydraulic force generated by the pressure on the brake lever side even when the user presses with maximum force.

If the electronic controller E determines, based on the signal S indicative of the rotational speed of the front wheel R1, the necessity for an intervention of the ABS function, in a first phase, the electronic controller E supplies a relatively high level of electric current to the solenoid 15, so as to switch the valve unit 13 from the first operating condition to the second operating condition, but pushing the movable member 11 of the fluid accumulator 9 into its starting position illustrated in FIG. 1, despite the accumulation chamber 9 receiving pressurized fluid from the line 8 connected to the actuator cylinder 3 of the brake caliper.

In a second subsequent phase, the electronic controller progressively decreases the current intensity of the electric current supplied to the solenoid 15, in such a way that the valve unit 13 remains in its second operating condition illustrated in FIG. 3, while the movable member 11 of the fluid accumulator 9 moves away from its starting position (as illustrated in FIG. 3) because the force due to the pressure of the fluid arriving in the chamber 10 exceeds the force applied to the movable member 11 by the solenoid 15. The increase in the volume of the chamber 10 causes a progressive decrease in pressure in the line 8 connected to the actuator cylinder 3 of the brake caliper, with the consequent achievement of the ABS effect, which avoids the locking of the wheel during braking.

In this phase, the progressive decrease in pressure in the line 8 is controlled by the controller E as a function of the signal S indicative of the angular velocity of the front wheel R1 and based on a feedback signal from the sensor P1 that detects the pressure in the line 8.

In said condition, a one-way valve 13A forming part of the valve unit 13 automatically opens, putting the downstream line 8 connected to the actuator cylinder 3 of the brake caliper in communication with the upstream line 6 connected to the actuator cylinder 2 of the lever if, for any reason, the pressure of the downstream line 8 tends to exceed the pressure of the upstream line 6.

As indicated, the electronic controller E, in the phase of activating the ABS function, controls the current supplied to the solenoid 15, in order to establish a certain pressure level in the actuator cylinder of the brake caliper, solely as a function of the rotational speed of the wheel R1, and solely based on a feedback signal provided by the pressure sensor P1, without therefore the need to provide a sensor for the position of the movable member of the fluid accumulator.

In a third subsequent phase, the electronic controller E progressively increases the current intensity of the electric current supplied to the solenoid 15, in such a way that the movable member 11 of the fluid accumulator 9 returns to its starting position (illustrated in FIG. 2) due to the increase of the force F1 applied by the solenoid 15, while the valve unit 13 still remains in its second operating condition illustrated in FIG. 3.

Also in this phase, the controller E controls the current supplied to the solenoid 15, in order to establish a certain pressure level in the actuator cylinder of the brake caliper, solely as a function of the rotational speed of the wheel R1, and solely based on a feedback signal provided by the pressure sensor P1.

In a fourth subsequent phase, after the movable member 11 of the fluid accumulator 9 has returned to its starting position, and once the ABS functionality is no longer necessary, the electronic controller E interrupts the supply of electric current to the solenoid 15, whereby the valve unit returns to its first operating condition illustrated in FIG. 2, while the movable member of the fluid accumulator 9 remains in its starting position, illustrated in FIG. 1.

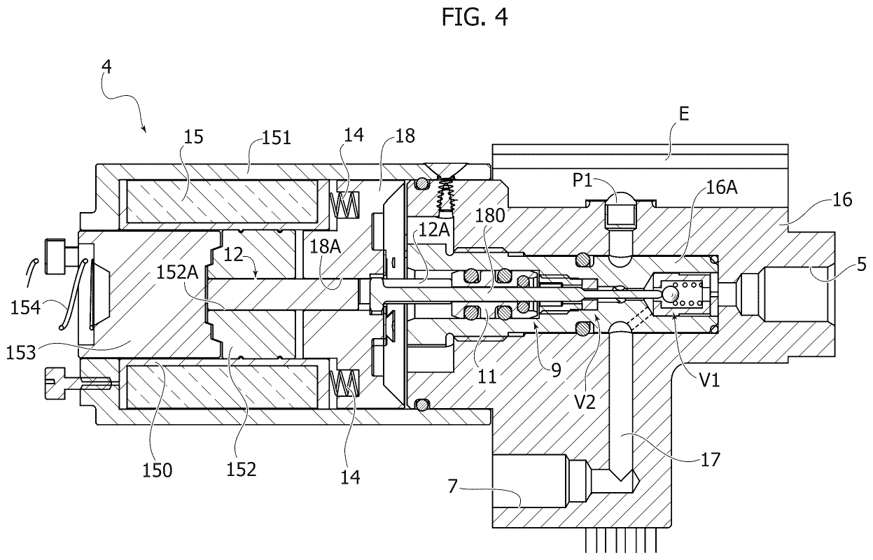

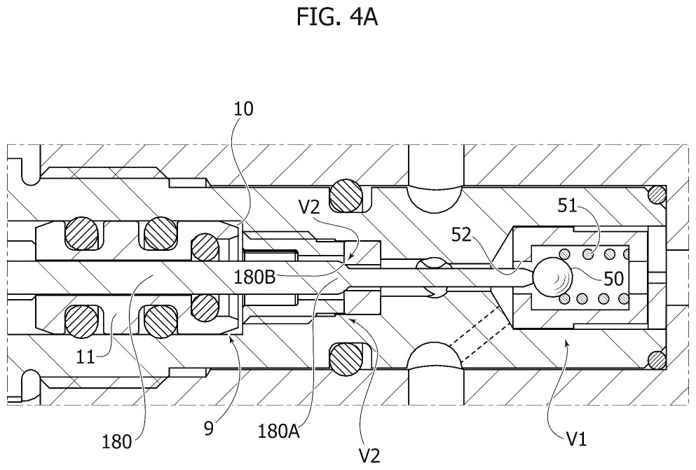

With reference now to FIGS. 4-8, relating to a concrete example of embodiment of the invention, the parts illustrated in these figures that functionally correspond to the parts illustrated in FIGS. 2, 3 are indicated with the same reference number.

In this example, the solenoid 15 is received between an inner tubular sleeve 150 and an outer cylindrical housing 151. Inside the cylindrical sleeve 151 is disposed a stator body 152 traversed by a central cylindrical cavity 152A within which the rod 12 of the piston constituting the movable member 11 of the fluid accumulator 9 is slidably mounted. Inside the tubular sleeve 150 is disposed a movable armature 153 in the form of a cylindrical body, which is maintained against the end of the rod 12 opposite the piston 11 by an anti-vibration spring 154.

The body 16 of the valve unit 13 defines the inlet 5 hydraulically connectable with the master cylinder of the brake lever, the outlet 7 to be hydraulically connected with the actuator cylinder of the brake caliper, and a main passage 17 that puts the inlet 5 in communication with the outlet 7.

In the body 16 of the valve unit 13 is mounted a cylindrical body 16A in which are disposed the fluid accumulator 9 and two valves V1, V2 which control respectively the communication between inlet 5 and outlet 7 and the communication between outlet 7 and the chamber 10 of the fluid accumulator 9.

FIG. 4 and FIG. 4A (which illustrates a detail of FIG. 4 on an enlarged scale) show the “idle” condition of the ABS device, when the ABS function is not required and the solenoid 15 is de-energized. In this condition, the valves V1 and V2, are respectively in an open condition and in a closed condition.

With reference to FIG. 4A, in the illustrated example, the valve V1 includes a ball 50 and a spring 51 that tends to recall the ball 50 towards a closed position on a valve seat 52. In the idle condition illustrated in FIGS. 4, 4A.

In the condition of FIGS. 4, 4A, i.e., when the solenoid is de-energized, the ball 50 is maintained in an open position, against the action of the spring 51, by an end of a pin 180 which is rigidly connected to an actuator member 18 (see FIG. 4), in the form of an annular disc, of ferromagnetic material, which is slidably mounted within the outer cylindrical housing 151 facing an end of the solenoid 15. When the solenoid 15 is de-energized, the actuator member 18 is maintained by springs 14 (interposed axially between facing surfaces of the solenoid 15 and the actuator member 18) in a position (towards the right with reference to FIGS. 4-7) in which the pin 180 maintains the ball 50 of the valve V1 in the open position, against the action of the spring 51. In this condition therefore the communication between inlet 5 and outlet 7 (i.e., between brake lever and brake caliper) is open.

With reference again to FIG. 4A, in the illustrated example, the valve V2 comprises a valve shutter constituted by a conical portion 180A of the pin 180, cooperating with a valve seat 180B defined by an annular element 180C mounted within the body 16A.

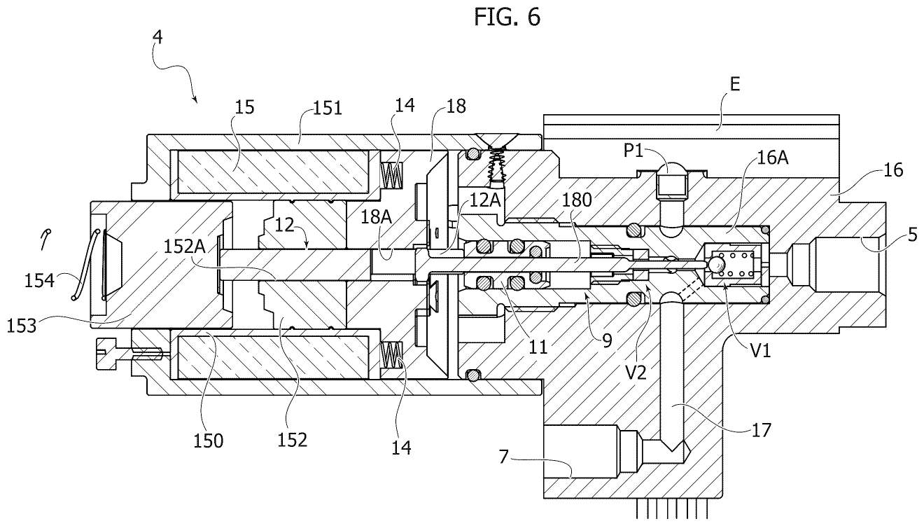

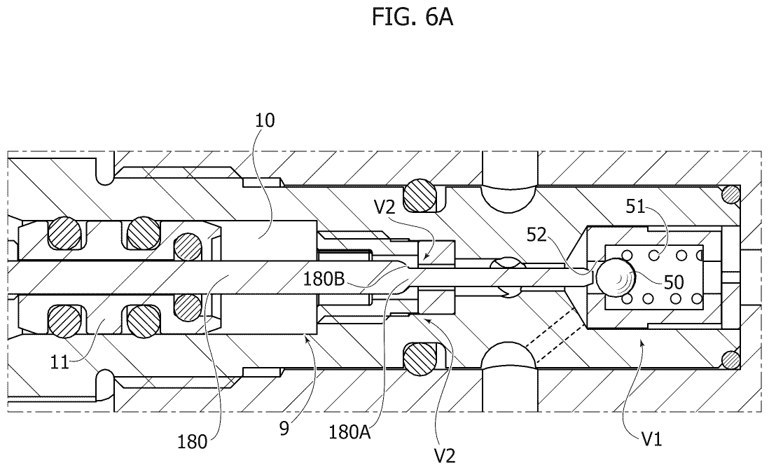

In the condition of FIGS. 4, 4A, i.e., when the solenoid is de-energized, the shutter 180A of the valve V2 is in its closed position, whereby it prevents a communication of the outlet 7 with the accumulation chamber 10 (better visible in FIG. 6A, which illustrates the active operating condition of the ABS device) of the fluid accumulator 9.

The annular disc constituting the actuator member 18 is of ferromagnetic material and has a central cylindrical cavity 18A traversed by the rod 12 of the movable member 11 of the fluid accumulator. The annular body constituting the actuator member 18 is rigidly connected to the pin 180 which controls the valves V1 and V2 in the manner described above. The rod 12 of the movable member 11 of the fluid accumulator 9 has a centrally grooved portion 12A to avoid interference with the pin 180, whereby the movements of the pin 180 and with it of the actuator member 18 and the movements of the rod 12 and of the movable member 11 of the fluid accumulator are independent of each other. For the same reason, the piston constituting the movable member 11 of the fluid accumulator 9, which consists of a cylindrical body rigidly connected to the centrally grooved portion of the rod 12, has an axial cavity for the passage of the pin 180. The cylindrical body constituting the movable member 11 of the fluid accumulator 9 is provided on its outer surface with sealing rings cooperating with the cylindrical wall of the cavity of the body 16A in which the movable member 11 is slidably mounted, and with at least one further internal sealing ring, cooperating with the pin 180.

Associated with the body 16 are also the pressure sensor P1, configured for detecting the pressure in the main passage 17 and an electronic board constituting the electronic controller E.

As already indicated with reference to FIGS. 4, 4A, when the solenoid 15 is de-energized, since the ABS function is not required, the actuator member 18 is maintained by the springs 14 in the position wherein the pin 180 maintains the valve V1 open and the valve V2 closed. In this situation, therefore, the inlet 5 and the outlet 7 communicate with each other through the main passage 17 and the first valve V1, while the accumulation chamber 10 of the fluid accumulator 9 is isolated from said main passage 17. The cyclist can therefore normally operate the brake device F by acting on the brake lever.

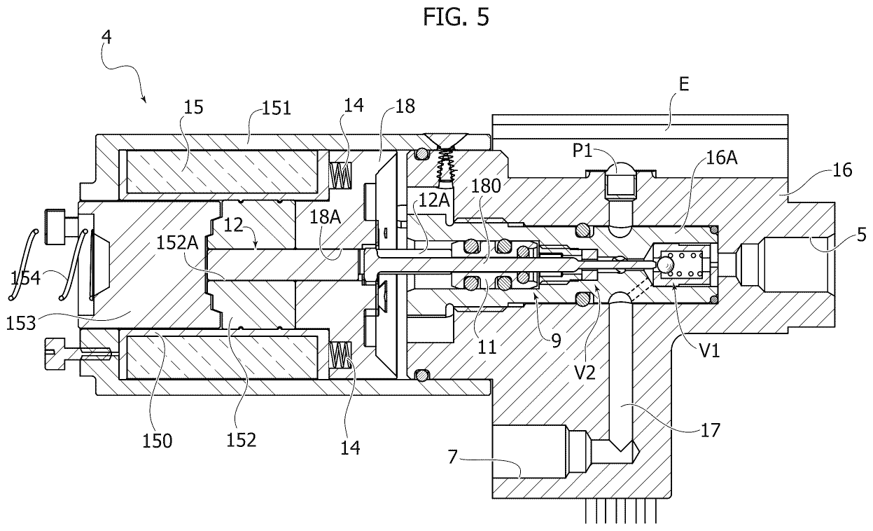

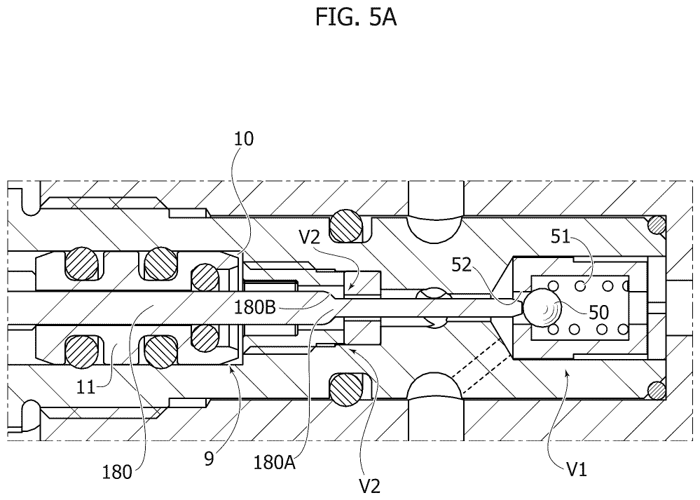

When the electronic controller E (see FIGS. 2,3) detects the necessity for intervention of the ABS function, based on the signal S which allows the detection or calculation of the rotational speed of the wheel R1, the electronic controller supplies the solenoid 15 with a relatively high current level so as to obtain the movement of the actuator member 18 into its operating position illustrated in FIG. 5, against the action of the springs 14 and at the same time the application of a force F by the movable armature 153 against the rod 12 of the movable member 11 of the fluid accumulator 9, tending to maintain the movable member 11 in the position corresponding to the minimum volume of the accumulation chamber 10. In this condition, illustrated in FIGS. 5 and 5A, the movement of the actuator member 18 determines the movement (towards the left with reference to the figures) of the pin 150, with consequent opening of the valve V2 and closing of the valve V1, whose ball shutter 50 is pushed into the closed position by its respective spring 51.

In this operating condition, decoupling (in the sense of an interruption of communication) between the brake lever side and the brake caliper side occurs, while the outlet 7 comes into communication, via the valve V2, with the accumulation chamber 10. However, in the condition of FIGS. 5, 5A, the movable member 11 of the fluid accumulator 9 is not able to move away from its starting position, because the solenoid supplied with a relatively high current level applies to the rod 12 of the movable member 11, via the movable armature 153, a force sufficient to counteract such movement.

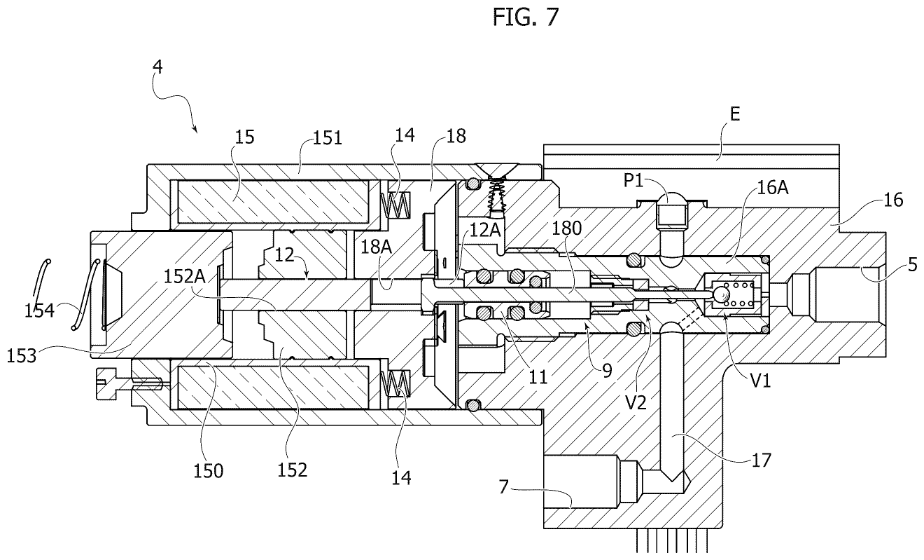

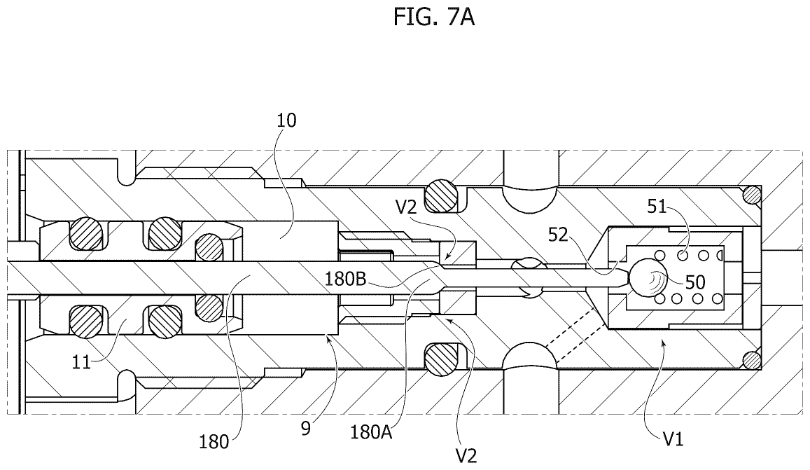

Once the operating condition illustrated in FIG. 5 has been reached, i.e., once the valves V1, V2 have been switched to the closed condition and the open condition respectively, the electronic controller E can progressively decrease the supply current of the solenoid 15 in such a way that the actuator member 18 remains in the operating position illustrated in FIG. 7, while the movable armature 153 exerts an increasingly lower force against the rod 12, whereby the movable member 11 is able to move away from its starting position, thus causing an increase in the volume of the accumulation chamber 10. This condition is illustrated in FIGS. 6 and 6A.

The progressive decrease in pressure on the caliper side is controlled by the electronic controller solely as a function of the signal S indicative of the rotational speed of the front wheel and solely based on a feedback signal provided by the pressure sensor P1.

In this condition, if for any reason the pressure on the brake caliper side tends to become greater than the pressure on the brake lever side, the valve V1 opens automatically, acting as a safety valve, so as to discharge the excess pressure from the line connected to the outlet 7 to the line connected to the inlet 5.

When the need for the ABS effect ceases, the electronic controller progressively increases again the supply current of the solenoid 15, up to a sufficiently high level to cause the movable armature 153 to push the rod 12 and with it the movable member 11 back into the starting position, corresponding to the minimum volume of the accumulation chamber. Once this condition is reached, the electronic controller E de-energizes the solenoid 15, so as to return the ABS device 4 to the starting condition illustrated in FIG. 4.

It should be noted that the spring 154 is a spring with a relatively low load, which has the sole function of maintaining the movable armature 153 against the rod 12, avoiding vibrations of the armature 153. In other words, the spring 154 is not capable of acting as a return spring for the movable member 11 towards its starting position. This return action, in the ABS device of the present invention, is performed by the solenoid 15. In other words, the ABS device 4 would be able to operate even if the spring 154 were eliminated.

It should also be noted that the return action of the solenoid 15 is not necessary to guarantee a safety condition, because it is the actuator member 18 which, by effect of the safety springs 14, in the absence of electrical power returns the system to the starting condition (see FIGS. 7 and 7A).

Therefore, the spring 14 (or springs 14) associated with the actuator member 18 is configured in such a way that, in the absence of an energization of the solenoid 15, the actuator member 18 remains in a position wherein it maintains the first valve V1 open and the second valve V2 closed, even in the presence of an increase in pressure in the main passage 17 determined by a braking action, as long as the necessity for an intervention of the ABS function does not occur.

In the example illustrated in FIGS. 4-8, the spring 154 is interposed between one end of the movable armature 153 protruding outside the device 4 and a wall (not visible in the drawings) made by a plastic cover having the sole function of providing a reaction for the spring 154 and ensuring sealing.

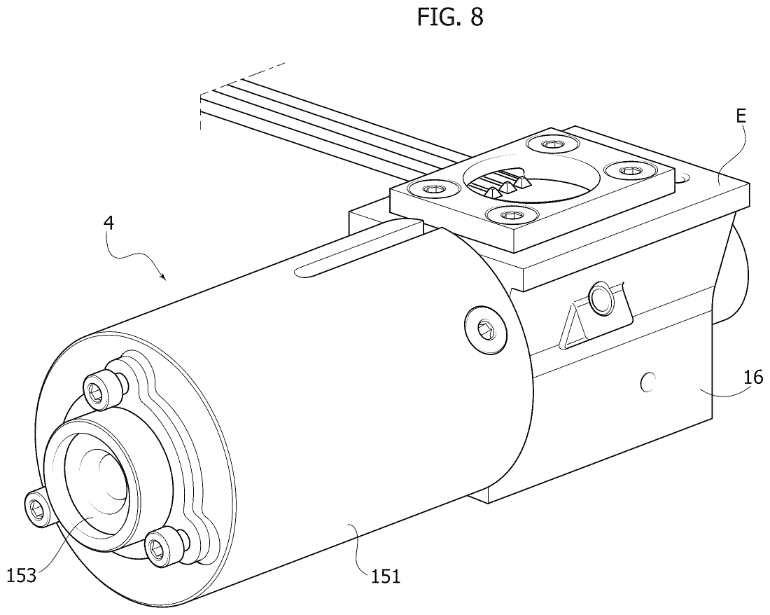

FIG. 8 shows an overall view of the ABS device 4.

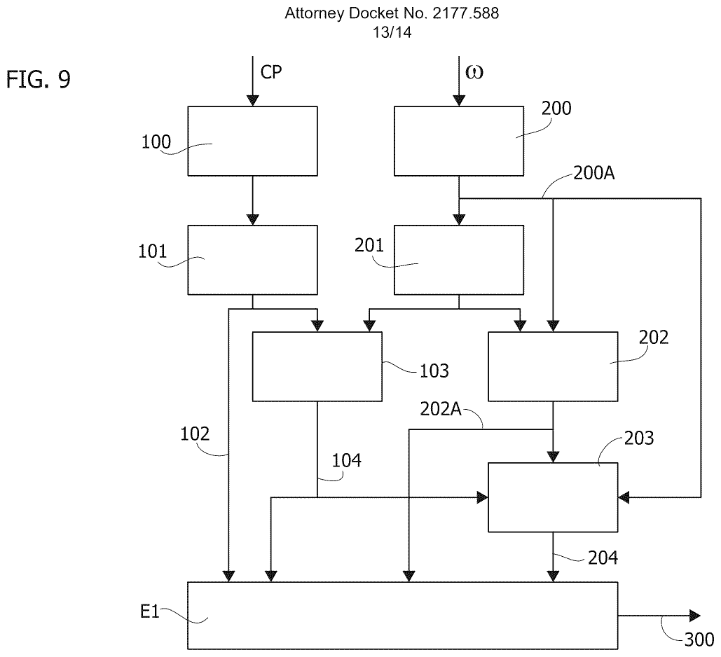

FIG. 9 shows an example of the method for controlling the current supplied to the electrically actuated valve unit of the ABS device during braking, implementable in the electronic controller E of the ABS device. In the case of the forms of embodiment illustrated here by way of example, the method controls the electric current supplied to the solenoid 15.

The entire controlling method illustrated in FIG. 9 is based on two parameters: the pressure CP in the line connected to the actuator cylinder 3 of the brake device and the rotational speed w of the front wheel of the vehicle to which the brake device is associated. As an alternative to the pressure CP, the method can be based on the deceleration of the vehicle detected by a sensor (for example an inertial platform) or calculated, for example based on the detection of the vehicle speed.

In blocks 100 and 200 the signal relating to the pressure CP, coming from the sensor P1, and the signal relating to the rotational speed ω, coming from the sensor SE, are processed and filtered, to estimate the braking intensity in block 101, and the vehicle speed in block 201.

Based on the estimate of the braking intensity performed in block 101, a signal 102 is sent to a supervisor module E1 of the electronic controller E to modulate the pressure CP progressively (in the example via the sending of a signal 300 that controls the current supplied to the solenoid 15 of the ABS device).

In parallel to the signal 102, based on the estimate of the braking intensity in block 101, and based on the estimate of the vehicle speed in block 201, in block 103 an estimate of the risk of forward overturning of the vehicle is performed, from which a signal 104 indicative of said overturning risk is derived, which is sent to the supervisor E1.

In block 202, based on the estimate of the vehicle speed performed in block 201, and based on the value of the rotational speed of the front wheel processed in block 200 (line 200A), an estimate of the slip of the front wheel relative to the ground is performed.

Based on the estimate performed in block 202, based on the signal 104 relating to the risk of forward overturning and based on the signal 200A relating to the rotational speed of the front wheel, in block 203 the adhesion condition of the front wheel to the ground is estimated according to a scale of values, including at least a value corresponding to “high adhesion” and a value corresponding to “low adhesion”.

The estimate performed in block 203 generates the sending to the supervisor module E1 of a signal 204 indicative of a target value of the pressure CP in the actuator cylinder 3 of the brake device.

The supervisor E1, based on the signal 102 indicative of the braking intensity, based on the signal 104 indicative of the risk of forward overturning of the vehicle, based on a signal 202A indicative of the estimate of the degree of adhesion of the front wheel of the vehicle relative to the ground and based on the signal 204 indicative of the target value of the pressure CP is able to output a signal 300 that controls the supply current of the solenoid 15 in order to obtain the desired pressure CP, according to a loop process, based on a feedback signal of the pressure CP detected by the sensor P1.

In this way, the system according to the invention is able to optimally control the braking, progressively varying the pressure CP during the intervention of the ABS function and during the restoration of the pressure CP when the ABS function is deactivated.

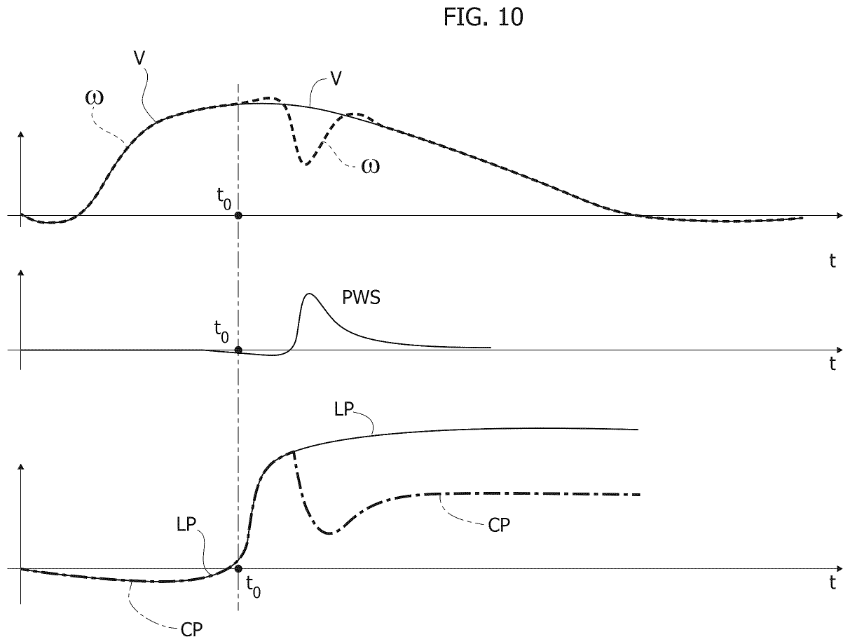

FIG. 10 shows the variation over time of some parameters (vehicle speed V, rotational speed ω of the front wheel, degree of adhesion of the wheel relative to the ground, pressure LP in the master cylinder 2 associated with the brake lever and pressure CP in the actuator cylinder 3 of the brake device) during a so-called “panic” braking (i.e., a sudden and forceful braking due to an unforeseen situation), on a slippery surface.

The diagram at the top of FIG. 10 shows the variation over time of the signal indicative of the vehicle speed V and of the signal indicative of the rotational speed ω of the front wheel, before and after a time to at which a user actuates the brake device of the front wheel.

Until time t₀ the two signals coincide, while after time to the rotational speed ω of the wheel has a more abrupt decrease, indicative of a tendency of the wheel to lock, which triggers the intervention of the ABS function. Following this intervention, the rotational speed of the wheel ω starts to rise again to return to a variation corresponding to the variation of the vehicle speed V.

The diagram in the middle of FIG. 10 shows the corresponding variation of the degree of adhesion of the wheel to the ground, during braking.

The lower diagram in FIG. 10 shows the corresponding variations of the pressure LP in the master cylinder 2 associated with the brake lever and of the pressure CP in the actuator cylinder 3 of the brake device (typically the brake caliper). This diagram shows that the system is configured to implement a non-abrupt, progressive variation of the pressure CP, both when the ABS function intervenes and when it ceases its action. Naturally, without prejudice to the principle of the invention, the details of construction and the forms of embodiment may vary widely with respect to what has been described and illustrated by way of example only, without thereby departing from the scope of the present invention, as defined in the appended claims.

1. ABS device for a hydraulic braking system of a cycle or motorcycle or of a light vehicle, comprising:
an inlet, to be hydraulically connected to a master cylinder associated with a brake lever,
an outlet to be hydraulically connected to an actuator cylinder associated with a brake device that is intended to be associated with a wheel of the vehicle,
a fluid accumulator having an accumulation chamber defined by a movable member within a cavity, said movable member being normally in a starting position corresponding to a minimum volume of the accumulation chamber,
an electrically actuated valve unit switchable between:
a first operating condition, in which said inlet and said outlet communicate with each other and said accumulation chamber of the fluid accumulator is isolated, and
a second operating condition in which the communication between said inlet and said outlet is interrupted and the accumulation chamber of said fluid accumulator is in communication with said outlet, and
an electronic controller configured for detecting a condition in which activation of an ABS function is required and which, in said condition, is further configured for causing a switching of said valve unit from the first operating condition to the second operating condition and for enabling a movement of the movable member of the fluid accumulator in a direction corresponding to an increase in the volume of the accumulation chamber, so as to cause a decrease in pressure in the connection line between said outlet and the actuator cylinder of the brake device,
said electronic controller configured for controlling the position of the movable member of the fluid accumulator, both during an activation of the ABS function and during a deactivation of the ABS function, so as to cause a non-abrupt, progressive variation of the pressure in the line connected to the actuator cylinder of the brake device, both during an activation of the ABS function and during a deactivation of the ABS function,
said progressive pressure variation being determined by the electronic controller as a function of:
a first parameter, which is the rotational speed of said wheel to which the brake device is associated, detected or calculated based on a signal emitted by a sensor intended to be associated with the wheel, and also as a function of:
a second parameter, which is:
either the pressure in the actuator cylinder of the brake device,
or the deceleration of the vehicle detected or calculated based on a sensor intended to be associated with the vehicle.

2. ABS device according to claim 1, wherein:
the switching of said valve unit between the first operating condition and the second operating condition is controlled by a solenoid that is operatively associated with the movable member of said fluid accumulator and that is configured and arranged in such a way that when said solenoid is energized it causes:
both a switching of said valve unit from the first operating condition to the second operating condition,
and the application of a force on said movable member of the fluid accumulator tending to push the movable member towards its starting position corresponding to a minimum volume of the accumulation chamber,
when the electronic controller determines said condition in which activation of the ABS function is required, the electronic controller is programmed to execute the following operations:
in a first phase, supply a relatively high level of electric current to said solenoid, so as to switch the valve unit from the first operating condition to the second operating condition, but pushing the movable member of the fluid accumulator into its starting position,
in a second subsequent phase, progressively decrease the current intensity of the electric current supplied to said solenoid, in such a way that the valve unit remains in its second operating condition, while the movable member of the fluid accumulator moves away from its starting position, so as to cause a progressive decrease in pressure in the connection line between said outlet and the actuator cylinder of the brake device,
in a third subsequent phase, progressively increase the current intensity of the electric current supplied to said solenoid, in such a way that the movable member of the fluid accumulator returns to its starting position, determining a progressive increase in pressure in the connection line between said outlet and the actuator cylinder of the brake device, while the valve unit remains in its second operating condition,
in a fourth subsequent phase, after the movable member of the fluid accumulator has returned to its starting position, and once the ABS functionality is no longer necessary, the electronic controller interrupts the supply of electric current to said solenoid, whereby the valve unit returns to its first operating condition while the movable member of the fluid accumulator remains in its starting position.

3. ABS device according to claim 1, wherein said electronic controller is configured for receiving a signal indicative of the pressure in the connection line to the actuator cylinder of the brake device from a sensor associated with said connection line and for controlling, in said second phase and in said third phase, a progressive variation of the pressure in the connection line to the actuator cylinder of the brake device as a function of a signal indicative of the rotational speed of the wheel to which the ABS device is intended to be associated and based on a signal from said pressure sensor.

4. ABS device according to claim 1, wherein said valve unit includes:
a main passage connecting said inlet with said outlet,
a first valve interposed in said main passage between said inlet and said outlet and which is in an open position in said first operating condition of the valve unit,
a second valve that controls a connection between said main passage and the accumulation chamber of the fluid accumulator, and which is in a closed position in said first operating condition of the valve unit,
an actuator member, movable against the action of a spring due to an energization of said solenoid in such a way as to simultaneously bring the first valve into a closed position and the second valve into an open position, and
in case of lack of electrical power to the solenoid, the spring associated with the actuator member recalls the actuator member into the position in which the spring maintains the first valve open and the second valve closed, even in the presence of an increase in pressure in said main passage determined by a braking action.

5. ABS device according to claim 4, wherein:
said solenoid is mounted between an inner tubular sleeve and an outer cylindrical housing,
within said inner tubular sleeve are arranged, axially aligned, a stator body, and a movable armature, slidably mounted within said inner tubular sleeve and connected to the movable member of the fluid accumulator, in such a way that following an energization of the solenoid the movable armature applies a force to the movable member in the direction of a decrease in the volume of the accumulation chamber.

6. ABS device according to claim 5, wherein the stator body has a central cylindrical cavity within which a rod is slidably mounted, which rigidly connects the movable armature to the movable member of the fluid accumulator.

7. ABS device according to claim 6, wherein:
said valve unit comprises a valve body rigidly connected to said outer cylindrical housing of the solenoid,
said actuator member is an annular element interposed axially between one end of said stator body and the body of the valve unit, said actuator member being pushed by one or more springs towards a first operating position in which the one or more springs maintains said first valve open and said second valve closed, and being recallable against the end of said stator body facing it following an energization of the solenoid, in such a way as to cause a closure of the first valve and an opening of the second valve.

8. ABS device according to claim 7, wherein said actuator member controls said first valve and said second valve by means of an axial pin having a portion acting as a valve member of the second valve and a terminal end that controls the position of the valve member of said first valve.

9. Method for controlling an ABS function in a hydraulic braking system of a cycle or motorcycle, in particular of a bicycle, wherein there is provided:
an inlet, to be hydraulically connected to a master cylinder associated with a brake lever,
an outlet, to be hydraulically connected to an actuator cylinder associated with a brake device, intended to be associated with a wheel of the vehicle,
a fluid accumulator having an accumulation chamber defined by a movable member within a cavity, said movable member being normally in a starting position corresponding to a minimum volume of the accumulation chamber,
an electrically actuated valve unit, switchable between:
a first operating condition, in which said inlet and said outlet communicate with each other and said accumulation chamber of the fluid accumulator is isolated, and
a second operating condition in which the communication between said inlet and said outlet is interrupted and the accumulation chamber of said fluid accumulator is in communication with said outlet,
said method comprising the operation of detecting, by means of an electronic controller, a condition in which activation of an ABS function is required and of causing, in said condition, a switching of said valve unit from the first operating condition to the second operating condition, also enabling a movement of the movable member of the fluid accumulator in a direction corresponding to an increase in the volume of the accumulation chamber, so as to cause a decrease in pressure in the connection line between said outlet and the actuator cylinder of the brake device,
the method comprises controlling, by means of said electronic controller, the position of the movable member of the fluid accumulator, both during an activation of the ABS function and during a deactivation of the ABS function, so as to cause a non-abrupt, but progressive, variation of the pressure in the line connecting to the actuator cylinder of the brake device, both during an activation of the ABS function and during a deactivation of the ABS function,
said progressive pressure variation being determined, by means of said electronic controller, as a function of:
a first parameter, which is the rotational speed of said wheel to which the brake device is associated, detected or calculated based on a signal emitted by a sensor intended to be associated with the wheel, and also as a function of:
a second parameter, which is:
the pressure in the actuator cylinder associated with the brake device,
or the deceleration of the vehicle detected or calculated based on a sensor intended to be associated with the vehicle.

10. Method according to claim 9, wherein:
the switching of said valve unit between the first operating condition and the second operating condition is controlled by a solenoid that is operatively associated with the movable member of the fluid accumulator and that is configured and arranged in such a way that when said solenoid is energized it causes:
both a switching of said valve unit from the first operating condition to the second operating condition,
and the application of a force on said movable member of the fluid accumulator tending to push the movable member towards its starting position, corresponding to a minimum volume of the accumulation chamber,
the condition in which activation of an ABS function is required is determined solely based on a signal indicative of the rotational speed of the wheel to which said brake device is intended to be associated,
when said condition in which activation of an ABS function is required is determined, the following operations are executed:
in a first phase, supply a relatively high level of electric current to said solenoid, so as to switch the valve unit from the first operating condition to the second operating condition, but pushing the movable member of the fluid accumulator into its starting position,
in a second subsequent phase, progressively decrease the current intensity of the electric current supplied to said solenoid, in such a way that the valve unit remains in its second operating condition, while the movable member of the fluid accumulator moves away from its starting position, so as to cause a progressive decrease in pressure in the connection line between said outlet and the actuator cylinder of the brake device,
in a third subsequent phase, progressively increase the current intensity of the electric current supplied to said solenoid, in such a way that the movable member of the fluid accumulator returns to its starting position, determining a progressive increase in pressure in the connection line between said outlet (and the actuator cylinder of the brake device, while the valve unit remains in its second operating condition,
in a fourth subsequent phase, after the movable member of the fluid accumulator has returned to its starting position, and once the ABS functionality is no longer necessary, the electronic controller interrupts the supply of electric current to said solenoid, whereby the valve unit returns to its first operating condition while the movable member of the fluid accumulator remains in its starting position.

11. Method according to claim 9, further comprising the operation of receiving, in said electronic controller, a signal indicative of the pressure in the line connecting to the actuator cylinder of the brake device from a sensor associated with said connection line and the operation of controlling, in said second phase and in said third phase, a progressive variation of the pressure in the line connecting to the actuator cylinder of the brake device as a function of said signal indicative of the rotational speed of the wheel to which the ABS device is associated and based on a signal from said pressure sensor.

12. Method according to claim 9, further comprising a fifth phase for compensating for any fluid leakage from the first valve to the second valve during their switching, by means of a “cleaning” cycle, wherein:
the user is not braking,
current is supplied to the solenoid to open the second valve,
the movable member of the fluid accumulator goes to its starting position, emptying the accumulation chamber,
the fluid subsequently flows from the line of the brake device to the line of the brake lever thanks to a relief function of the first valve.

13. Method according to claim 9, further comprising performing, during an activation of the brake device, via said electronic controller, the following operations:
processing a signal indicative of said second parameter to estimate the braking intensity
processing a signal indicative of said first parameter to estimate the vehicle speed,
based on the estimate of the braking intensity, sending a signal to a supervisor module of the electronic controller to modulate the pressure in the actuator cylinder of the brake device progressively, via the sending of a signal 300 that controls the current supplied to said electrically actuated valve unit,
based on the estimate of the braking intensity, and based on the estimate of the vehicle speed, estimating a risk of forward overturning of the vehicle, and sending a signal indicative of said overturning risk to the supervisor module,
based on the estimate of the vehicle speed, and based on a signal indicative of said first parameter, estimating a degree of slip of the vehicle wheel relative to the ground,
based on the estimate of the degree of slip, based on the signal indicative of the forward overturning risk and based on the signal indicative of the rotational speed of the vehicle wheel, estimating the wheel grip condition on the ground according to a scale of values, including at least a value corresponding to “high grip” and a value corresponding to “low grip”.
based on the estimate of the degree of grip, sending to the supervisor module a signal indicative of a target value of the pressure in the actuator cylinder of the brake device.
based on the signal indicative of the braking intensity, based on the signal indicative of the forward overturning risk of the vehicle, based on a signal indicative of the estimate of the degree of grip of the vehicle wheel relative to the ground and based on the signal indicative of the target value of the pressure in the actuator cylinder of the brake device, generating, via said supervisor module, a signal that controls the current supplied to the electrically actuated valve unit, in order to achieve the target pressure in the actuator cylinder of the brake device, according to a loop process, based on a feedback signal of said pressure detected by a sensor.
